(19) United States
(12) Patent Application Publication
(10) Pub. No.: US 2011/0136719 A1
(43) Pub. Date: Jun. 9, 2011

(54) Dissolvable laundry detergent sheet

(75) Inventors: Luc Jalbert, Shediac (CA); Marc Surette, Moncton (CA)

(73) Assignee: Dizolve Group Corporation, Moncton (CA)

(21) Appl. No.: 12/660,742

(22) Filed: Mar. 2, 2010

Related U.S. Application Data
(60) Provisional application No. 61/156,866, filed on Mar. 2, 2009.

(51) Int. Cl. C11D 17/00; C11D 3/60

(52) U.S. Cl. 510/298; 510/340

(57) ABSTRACT

A flexible laundry sheet made of a mixture of at least a thickening agent, detergent, water and polyvinyl alcohol. The thickening agent is comprised of polymers such as starch, modified starch, or cellulose that, when dried, produce a material that remains solid and flexible when dry, yet dissolves completely in water. The constituents, once mixed in the proper proportion, produce a liquid that is poured onto a drying plate, and after drying results in a flexible, dry, laundry sheet which may be added to laundry. Once in contact with water the laundry sheet dissolves and releases its active ingredients, which may include detergents, surfactants, water softeners, chelating agents, dyes, fragrances, clothes softeners and bleaching agents.

### CROSS-REFERENCE TO RELATED APPLICATION

This application claims priority of U.S. Provisional Application No. 61/156,866, filed Mar. 2, 2009, under Title 35, United States Code, Section 119(e).

### BACKGROUND OF THE INVENTION

1. Field of the Invention

This invention generally relates to detergent for a washing machine, and specifically to dissolvable washer sheets containing detergent for use in a washing machine.

2. Description of the Prior Art

Washing detergent is typically found in a liquid or powder form. Powder detergent frequently does not completely dissolve, leaving residue and forcing a second wash cycle. Liquid or powder may be messy if spilled and difficult to clean up. Consumers require that laundry products clean their clothes without harming them, and would like that the detergent products look appealing, smell pleasant, and brighten clothing as well as clean it. Consumers would prefer laundry products that are simpler and less messy than liquids or powder

There has been some attempt in the prior art by inventors trying to find a solution to this problem of liquid or powder detergent by using a sheet. U.S. Pat. No. 4,938,888 discloses a detergent combination impregnated into a flexible substrate. The substrate is composed of woven paper or cloth, however, one drawback is that the substrate remains in the washer after completion of the wash cycle, due to its inability to dissolve. In U.S. Pat. No. 4,853,142, a plastic web which holds detergent is disclosed, but again this suffers from the same drawback as the paper or cloth mentioned above, that is, the web remains in the washer after completion of the wash cycle.

Other attempts to provide a detergent sheet product are described in U.S. Pat. Nos. 6,818,606 and 7,094,744 wherein a soluble substrate is covered with a layer of detergent on each side of the soluble substrate. The major drawback of this product is the complex method required to produce such a product as well as the introduction of elements which within the soluble substrate do not participate or add any value to the cleaning of the garments in the washing machine.

Therefore, there is a need for detergent in a sheet form that is easy to handle and store when dry, yet dissolves completely in the laundry cycle without leaving a residue. It is desirable that this product also cleans clothes without harming them, and that the detergent sheet looks appealing, smells pleasant, and brightens clothing in addition to cleaning it.

### SUMMARY OF INVENTION

The described invention is a flexible laundry sheet made of a mixture of detergents, surfactants, water conditioners and thickening agents. The thickening agents are composed of polymers such as starch, modified starch, or cellulose that, when dried, produce a material that remains solid and flexible when dry, yet dissolves completely in water. The material, once mixed in the proper proportion, produces a liquid that is poured onto a drying plate, and after evaporation of excess water results in a sheet that remains solid and flexible, yet also water soluble. This sheet can then be placed into a laundry machine, and will release the constituents on addition of water.

In the preferred embodiment, the laundry sheet is composed of a mixture of at least starch; a detergent such as Alpha (α) olefin sulfonate; water; and polyvinyl alcohol, these four ingredients comprising approximately 97% of the mixture. The remaining 3% is composed of a mixture of sodium laureth sulfate; and sulfonic acid; methylparaben, propylparaben, fluorescent brightener, caustic soda flake (sodium hydroxide), Ethylenediaminetetraacetic acid tetrasodium salt EDTA tetrasodium, penetrating agent JFC, cocamide DEA, and sodium chloride. In other embodiments, fragrances, dyes and bleaching agents may be present.

### DETAILED DESCRIPTION OF THE INVENTION

The present invention will now be described more fully hereinafter with reference to the accompanying drawings, in which preferred and other embodiments of the invention are shown. No embodiment described below limits any claimed invention and any claimed invention may cover processes or apparatuses that are not described below. The claimed inventions are not limited to apparatuses or processes having all the features of any one apparatus or process described below or to features common to multiple or all of the apparatuses described below. It is possible that an apparatus or process described below is not an embodiment of any claimed invention. The applicants, inventors or owners reserve all rights that they may have in any invention claimed in this document, for example the right to claim such an invention in a continuing application and do not intend to abandon, disclaim or dedicate to the public any such invention by its disclosure in this document.

The described invention is a flexible sheet made of a mixture of detergents, surfactants, water conditioners and thickening agents. The thickening agents are composed of polymers such as starch, modified starch, or cellulose that, when dried, produce a material that remains solid and flexible when dry, yet dissolves completely in water. The ingredients of the sheet, once mixed in the proper proportions, combine to produce a liquid that may be poured onto a large warmed drying plate, which liquid spreads over the plate to form a coating of uniform thickness, which then dries. The resulting sheet is between 0.1 mm and 5 mm thick, and may be cut into laundry-load-sized portions. The resulting laundry sheet remains solid and flexible, yet is water soluble. This sheet can then be placed into a laundry machine, and will release the detergent and other constituents on addition of water. Once the laundry load is complete, the constituents of the sheet depart with the waste water.

In the preferred embodiment, the ingredients forming the laundry sheet comprise a mixture of rice starch in the amount of 47.15%; Alpha (α) olefin sulfonate (Sodium C14-16 olefin sulfonate) in the amount of 21.22%; water in the amount of 17.68%; polyvinyl alcohol in the amount of 10.6%; fatty-alcohol-polyoxyethylene ether (sodium laureth sulfate or SLES) in the amount of 1.24%; and dodecyl benzene sulfonic acid (sulfonic acid) in the amount of 1.06%. The remaining 1% is composed of a mixture of methylparaben, propylparaben, fluorescent brightener, caustic soda flake (sodium hydroxide), Ethylenediaminetetraacetic acid tetrasodium salt (EDTA tetrasodium), penetrating agent JFC, coconut diethanolamide (cocamide DEA), and sodium chloride. Once the mixture is cured on the drying plate, the water content is reduced to approximately 1%. In other embodiments, bleaching agents such as sodium percarbonate and fabric softeners which are based on quaternary ammonium cations/salts or silicone based compounds such as cetrimonium bromide, quaternary ammonium chloride or polydimethylsiloxane may be present.

Rice starch, a polysaccharide carbohydrate, is a thickening agent and provides the body for the sheet, and absorbs the other constituents and holds them in a largely inert state while they are transported, and stored. Once the sheet is placed into water in the laundry machine, the starch dissolves into the water and releases the active laundry-cleaning ingredients. The starch is almost completely dissolved in the water, and does not leave a residue at the end of the laundry cycle. One skilled in the art would know that rice starch may be substituted by any one of many other starches, including corn starch, potato starch, wheat starch, and tapioca starch. The amount of starch may vary from about 25% to 60%, depending on the other ingredients, and still produce the sheet that is the subject of this patent application.

A detergent such as Alpha (α) olefin sulfonate is used is used as a surfactant and foaming agent combining cleaning activity for liquid soaps, washing compounds and liquid detergents. It provides acid resistance and biodegrability. One skilled in the art would appreciate that Alpha (α) olefin sulfonate may be substituted by sodium lauryl sulfate (SLS), also a surfactant, as well as other surfactants known in the art. The amount of Alpha (α) olefin sulfonate may range from 15% to 40%. Lower concentrations of Alpha (α) olefin sulfonate are needed for high-efficiency washing machines, and higher concentrations, in the order of 35%, are required for less-efficient top-loading machines.

Water is a component of the invention as a solvent; it facilitates the mixing of constituents, and while the vast majority of the water evaporates on the drying of the sheet, it provides sufficient moisture for the final sheet product to be flexible instead of brittle.

Polyvinyl alcohol is used as a thickener for the constituents of the sheet, and helps to hold the sheet together, as well as providing some elastic property to the sheet, preventing brittleness. It has film forming, emulsifying, and adhesive properties. It is odorless and nontoxic. Combination with the water present, which acts as a plasticizer, increases the polyvinyl alcohol's elongation and tear strength, and produces a resilient sheet. Polyvinyl alcohol exists in the sheet in the amount of 5-15%, while still producing a laundry sheet that falls within the scope of the invention.

Therefore, the essential components of a laundry sheet are starch such as rice starch in the amount of 25%-60%, a detergent such as Alpha (α) olefin sulfonate in the amount of 15%-40%, Polyvinyl alcohol in the amount of 5-15%, and sufficient water to make the mixture into a liquid for formation on the drying plates, which water will largely evaporate in the final product, only 1% or so remaining. Of course, the constituents do not exceed 100%, and where more starch is used, for instance, less detergent may be present.

Further possible ingredients, which are optional to the detergent sheet, yet provide useful results for laundry cleanliness or consumer appeal, are described now.

Sodium laureth sulfate (SLES) is a detergent and surfactant, which is also a very effective foaming agent. Another possible ingredient, sulfonic acid, is a surfactant. While each of these ingredients are optional, they produce positive results for laundry cleansers, and if present would each be present in the range of 0-5%.

Methylparaben and propylparaben are chemicals used as preservatives in the laundry sheet. Parabens are effective preservatives in many types of formulas. These compounds, and their salts, are used in the sheet primarily for their bactericidal and fungicidal properties. Preservatives are optional in the present invention, however, but if present would constitute between 0-0.5% of the laundry sheet. One skilled in the art would know of other preservatives that may be substituted for the parabens described here.

Fluorescent brighteners, such as CIBA® TINOPAL CBS-X, are dyes that absorb light in the ultraviolet and violet region (usually 340-370 nm) of the electromagnetic spectrum, and re-emit light in the blue region (typically 420-470 nm). This additive is used to enhance the appearance of color of fabric causing a perceived “whitening” effect, making materials look less yellow by increasing the overall amount of blue light reflected. This is an optional ingredient which if present would appear in the amount of 0-0.5%.

Caustic soda flake (sodium hydroxide) is frequently used as an industrial cleaning agent, because it can dissolve grease, oils, fats and protein based deposits. In combination with the above surfactants, it also serves to stabilize dissolved substances to prevent redeposition. While the ingredient is optional, if present it would appear in the amount of 0-3%. Other bases would be known to one skilled in the art and could be substituted for a similar effect.

EDTA tetrasodium serves to dissolve scale, and as a chelating agent reducing the water hardness, and therefore increasing the effectiveness of detergents. It is able to bind and render less reactive metal ions such as Ca²⁺ and Fe³⁺. After being bound by EDTA, metal ions remain in solution but exhibit diminished reactivity. EDTA tetrasodium is optional and would appear in the amount of 0-0.5 if present. One skilled in the art would appreciate that other chelating agents may be used with the same result, among others the chemical groupings of zeolites and phosphonates.

Penetrating agent JFC (sodium butyl naphthalene sulphate), aids in permitting the constituents, once dissolved in water, to penetrate into stains and dirt in the clothing. It is optional and would appear in the amount of 0-2% if present. Cocamide DEA is a surfactant, and aids in foam production, is also optional, and would appear in the amount of 0-5% if present. It also increases the viscosity of the mixture that forms the sheet. Sodium chloride is table salt and is used to soften the water and increase the effectiveness of the above detergent cleansers and surfactants, and would appear in the amount of 0-5% if present.

In other embodiments, the proportions may be varied within limits, without deviating from the scope of the invention.

In another embodiment, fragrance and dyes to modify the aesthetics of the sheet, may be present in a proportion of 0-10% of the sheet. In yet another embodiment, the sheet may contain bleaching agents, present in the proportion of 0-5% of the sheet composition, or the bleaching agent may be present within another constituent such as in the case of oxidizing agent sodium percarbonate, which releases hydrogen peroxide when dissolved in water. Some other examples of bleaching agents that may be present are calcium hypochlorite, sodium hypochlorite, sodium perborate, sodium persulfate, tetrasodium pyrophosphate, and urea peroxide In other embodiments, fabric softeners which are based on quaternary ammonium cations/salts and silicone based compounds such as cetrimonium bromide, quaternary ammonium chloride or polydimethylsiloxane may be present.

Many modifications and other embodiments of the invention will come to the mind of a person skilled in the art having the benefit of the teachings presented in the foregoing description and associated drawings. Therefore, it is understood that the invention is not to be limited to the specific embodiment disclosed, and that modifications and embodiments are intended to be included within the scope of the appended claims.

We claim:

1. A dissolvable laundry sheet for use in cleaning clothes in a laundry machine, comprising the following components:
starch;
detergent;
water; and
polyvinyl alcohol, wherein the starch, detergent, water and polyvinyl alcohol are mixed together and dried, to form a sheet.

2. The sheet of claim 1 wherein the starch constitutes between 25-60% of the mixture and comprises one or more of corn starch, wheat starch, potato starch, rice starch or tapioca starch.

3. The sheet of claim 1 wherein the detergent constitutes between 15-40% of the mixture.

4. The sheet of claim 3 wherein the detergent is selected from the group consisting of alpha (α) olefin sulfonate and sodium lauryl sulphate.

5. The sheet of claim 1 wherein the water constitutes between 0-2% of the sheet.

6. The sheet of claim 1 wherein the polyvinyl alcohol constitutes between 5-15% of the mixture.

7. The sheet of claim 1 further comprising sodium laureth sulfate in the amount of 0-5% of the mixture.

8. The sheet of claim 1 further comprising sulfonic acid in the amount of 0-5% of the mixture, and parabens in the amount of 0-0.5% of the mixture.

9. The sheet of claim 1 further comprising a chelating agent selected from the group consisting of EDTA, zeolites and phosphonates in the amount of 0-0.5% of the mixture.

10. The sheet of claim 1 further comprising a sodium butyl naphthalene sulphate in the amount of 0-2% of the mixture, cocamide DEA in the amount of 0-5% of the mixture and sodium chloride in the amount of 0-5% of the mixture.

11. The sheet of claim 1 further comprising fragrance in the amount of 0-2% of the mixture, fluorescent brighteners in the amount of 0-0.5% of the mixture and sodium hydroxide in the amount of 0-3% of the mixture, and dye in the amount of 0-12% of the mixture.

12. The sheet of claim 1 further comprising a bleaching agent selected from the group consisting of calcium hypochlorite, sodium hypochlorite, sodium perborate, sodium percarbonate, sodium persulfate, tetrasodium pyrophosphate, and urea peroxide in the amount of 0-5% of the mixture.

13. The sheet of claim 1 further comprising a fabric softener, selected from the group consisting of quaternary ammonium cations/salts, cetrimonium bromide, quaternary ammonium chloride, and polydimethylsiloxane, in the amount of 0-10% of the mixture.

14. A mixture to form a dissolvable laundry sheet for use in cleaning clothes in a laundry machine, comprising the following components:
rice starch;
alpha (α) olefin sulfonate;
water;
polyvinyl alcohol;
sodium laureth sulfate;
sulfonic acid;
one or more parabens;
fluorescent brightener;
sodium hydroxide;
EDTA tetrasodium;
sodium butyl naphthalene sulphate;
cocamide DEA; and
sodium chloride, wherein said components are mixed together and dried, to form a sheet.

15. The sheet of claim 14, wherein
the rice starch constitutes between 25-60% of the mixture;
alpha (α) olefin sulfonate constitutes 15-40% of the mixture;
water constitutes 10-40% of the mixture; and
polyvinyl alcohol constitutes 5-15% of the mixture.
